(19) United States
(12) Patent Application Publication
(10) Pub. No.: US 2020/0099028 A1
(43) Pub. Date: Mar. 26, 2020

(54) BATTERY FASTENING STRUCTURE AND BATTERY FASTENING STRUCTURE ASSEMBLY INCLUDING THE SAME

(71) Applicant: Cheng Uei Precision Industry Co., Ltd., New Taipei City (TW)

(72) Inventors: GEN-YUAN CHANG, New Taipei City (TW); JEN-KAI HUANG, New Taipei City (TW)

(21) Appl. No.: 16/432,917

(22) Filed: Jun. 5, 2019

(30) Foreign Application Priority Data
Sep. 25, 2018 (CN) 201821574241.7

(51) Int. Cl. H01M 2/10; H01M 2/30

(52) U.S. Cl. CPC H01M 2/1083; B60L 50/66; H01M 2220/20; H01M 2/305

(57) ABSTRACT

A battery fastening structure includes an isolation unit and a conduction unit. The isolation unit opens a through-hole. The isolation unit has at least one combination unit. At least two battery fastening structures are fastened and combined by virtue of at least two combination units of the at least two battery fastening structures being buckled. Two opposite ends of the through-hole extend outward to form a first connecting hole and a second connecting hole, respectively. Two opposite ends of the conduction unit are received in the first connecting hole and the second connecting hole, respectively. The first connecting hole is designed to make one end of the conduction unit electrically connected with the positive pole of the battery, and the second connecting hole is designed to make the other end of the conduction unit electrically connected with the negative pole of the battery.

### CROSS-REFERENCE TO RELATED APPLICATION

The present application is based on, and claims priority form, China Patent Application No. 201821574241.7, filed Sep. 25, 2018, the disclosure of which is hereby incorporated by reference herein in its entirety.

### BACKGROUND OF THE INVENTION

### 1. Field of the Invention

The present invention generally relates to a battery fastening structure, and more particularly to a battery fastening structure for facilitating an electricity conduction of a battery fastened therein, and a battery fastening structure assembly including the same.

### 2. The Related Art

Nowadays, electric vehicles have gradually become favorite conveyances for people, so endurance requirements for the electric vehicles are increased day by day. An effective promotion of an energy density of a battery has become a purpose which every enterprise is anxious to reach. Because a current large capacity battery pack is mostly formed by way of connecting a lot of batteries. In order to ensure a safety of each battery in the current large capacity battery pack, a conventional battery fastening structure is adopted for fastening and connecting the battery.

However, the conventional battery fastening structure has following drawbacks. Firstly, the conventional battery fastening structure just plays fastening and connecting effects on the battery, nickel sheets must be further spot soldered to the batteries to make an electricity conduction among the batteries, and an external portion of the conventional battery fastening structure impedes an action of spot soldering the nickels to make a manufacture of the conventional battery fastening structure and the nickel sheets difficult. Secondly, when the nickel sheets are spot soldered, a damage of the batteries is probably caused to shorten lives of the batteries and even cause a potential safety hazard. Thirdly, positive poles and negative poles of the batteries are all exposed outside to be unable to effectively protect the batteries, if the batteries are damaged, liquids of the batteries are easily caused to be overflowed and the damage of the batteries are further enlarged.

### SUMMARY OF THE INVENTION

An object of the present invention is to provide a battery fastening structure. The battery fastening structure includes an isolation unit and a conduction unit. The isolation unit opens a through-hole penetrating through middles of a front surface and a rear surface of the isolation unit along an axis direction of the isolation unit. The isolation unit has at least one combination unit disposed to an outer peripheral surface of the isolation unit. At least two battery fastening structures are fastened and combined by virtue of at least two combination units of the at least two battery fastening structures being buckled. The conduction unit is disposed in the through-hole. Two opposite ends of the through-hole extend outward away from the middles of the front surface and the rear surface of the isolation unit to form a first connecting hole penetrating through the front surface of the isolation unit and a second connecting hole penetrating through the rear surface of the isolation unit, respectively. The conduction unit is neatly connected with the isolation unit, and two opposite ends of the conduction unit are received in and exposed in the first connecting hole and the second connecting hole, respectively. The first connecting hole is disposed to one end of the isolation unit and is designed for cooperating a positive pole of a battery to make one end of the conduction unit electrically connected with the positive pole of the battery, and the second connecting hole is disposed to the other end of the isolation unit and is designed for cooperating a negative pole of the battery to make the other end of the conduction unit electrically connected with the negative pole of the battery.

Another object of the present invention is to provide a battery fastening structure assembly. The battery fastening structure assembly includes at least two battery fastening structures for fastening at least one battery. Each battery fastening structure includes an isolation unit and a conduction unit. The isolation unit opens a through-hole penetrating through middles of a front surface and a rear surface of the isolation unit along an axis direction of the isolation unit. The isolation unit has at least one combination unit disposed to an outer peripheral surface of the isolation unit. The at least two battery fastening structures are fastened and combined by virtue of at least two combination units of the at least two battery fastening structures being buckled. The conduction unit is disposed in the through-hole. Two opposite ends of the through-hole extend outward away from the middles of the front surface and the rear surface of the isolation unit to form a first connecting hole penetrating through the front surface of the isolation unit and a second connecting hole penetrating through the rear surface of the isolation unit, respectively. The conduction unit is neatly connected with the isolation unit, and two opposite ends of the conduction unit are received in and exposed in the first connecting hole and the second connecting hole, respectively. The first connecting hole is disposed to one end of the isolation unit and is designed for cooperating a positive pole of a battery to make one end of the conduction unit electrically connected with the positive pole of the battery, and the second connecting hole is disposed to the other end of the isolation unit and is designed for cooperating a negative pole of the battery to make the other end of the conduction unit electrically connected with the negative pole of the battery.

Another object of the present invention is to provide a battery fastening structure assembly. The battery fastening structure assembly includes at least two battery fastening structures for fastening at least one battery. Each battery fastening structure includes an isolation unit and a conduction unit. The isolation unit opens a through-hole penetrating through middles of a front surface and a rear surface of the isolation unit along an axis direction of the isolation unit. The isolation unit has at least one combination unit disposed to an outer peripheral surface of the isolation unit. The at least two battery fastening structures are fastened and combined by virtue of at least two combination units of the at least two battery fastening structures being buckled. The conduction unit is disposed in the through-hole. Two opposite ends of the through-hole extend outward away from the middles of the front surface and the rear surface of the isolation unit to form a first connecting hole penetrating through the front surface of the isolation unit and a second connecting hole penetrating through the rear surface of the isolation unit, respectively. The conduction unit is neatly connected with the isolation unit. The conduction unit has a conductive column. One end of the conductive column is connected with a first fastening piece, and the other end of the conductive column is connected with a second fastening piece. The first fastening piece is received in the first connecting hole and an outer surface of the first fastening piece is exposed in the first connecting hole, and the second fastening piece is received in the second connecting hole and an outer surface of the second fastening piece opposite to the outer surface of the first fastening piece is exposed in the second connecting hole. The first connecting hole is located to one end of the through-hole of one battery fastening structure, and the first connecting hole is equipped with the first fastening piece for cooperating with a positive pole of one battery, and the first fastening piece in the first connecting hole is electrically connected with the positive pole of the one battery. The second connecting hole is located to the other end of the through-hole of the one battery fastening structure, and the second connecting hole is equipped with the second fastening piece for cooperating with a negative pole of the other battery, and the second fastening piece in the second connecting hole is electrically connected with the negative pole of the other battery.

As described above, the isolation unit and the conduction unit of the battery fastening structure are combined by an injection enveloping way, so that peripheries of the first fastening piece and the second fastening piece neatly abut against an inner surface of the isolation unit, when battery core liquids flow from the positive pole or the negative pole of the at least one battery carelessly, because the conduction unit is shown as H shape, and the first fastening piece or the second fastening piece is neatly connected with the isolation unit, the battery core liquids are effectively isolated to be avoided flowing from one end of the at least one battery to the other end of the at least one battery, an operation and a life of the other end of the at least one battery are affected. Moreover, most explosion and burn sources of the at least one battery are located at the positive pole or the negative pole of the at least one battery, the isolation unit is made of a fire-proof material, and the positive pole and the negative pole of the at least one battery are isolated and surrounded by the isolation unit, the seeped and flown battery core liquids are capable of being effectively isolated and a hazard of a serial of combustion of the at least one battery is further capable of being avoided.

### BRIEF DESCRIPTION OF THE DRAWINGS

The present invention will be apparent to those skilled in the art by reading the following description, with reference to the attached drawings, in which:

FIG. 1 is a perspective view of a battery fastening structure in accordance with the present invention;

FIG. 2 is a vertical view of the battery fastening structure in accordance with the present invention;

FIG. 3 is a perspective view of a conduction unit of the battery fastening structure in accordance with the present invention;

FIG. 4 is a sectional view of the battery fastening structure in accordance with the present invention;

FIG. 5 is a diagrammatic section view of an isolation unit of the battery fastening structure in accordance with the present invention;

FIG. 6 is a diagrammatic drawing showing a status of two battery fastening structures buckled with each other;

FIG. 7 is a diagrammatic drawing showing a battery fastening structure assembly which includes a plurality of battery fastening structures mutually assembled, wherein a plurality of batteries are fastened in the battery fastening structure assembly in accordance with a first preferred embodiment of the present invention;

FIG. 8 is another diagrammatic drawing showing the battery fastening structure assembly which includes the plurality of the battery fastening structures mutually assembled, wherein the plurality of the batteries are fastened in the battery fastening structure assembly in accordance with a second preferred embodiment of the present invention;

FIG. 9 is another diagrammatic drawing showing the battery fastening structure assembly which includes the plurality of the battery fastening structures mutually assembled, wherein the plurality of the batteries are fastened in the battery fastening structure assembly in accordance with a third preferred embodiment of the present invention;

FIG. 10 is a diagrammatic drawing of the battery fastening structure, wherein two batteries are connected by the battery fastening structure in accordance with the present invention; and

FIG. 11 is a diagrammatic drawing of the battery fastening structure, wherein two batteries are fastened and connected by three battery fastening structures.

### DETAILED DESCRIPTION OF THE PREFERRED EMBODIMENT

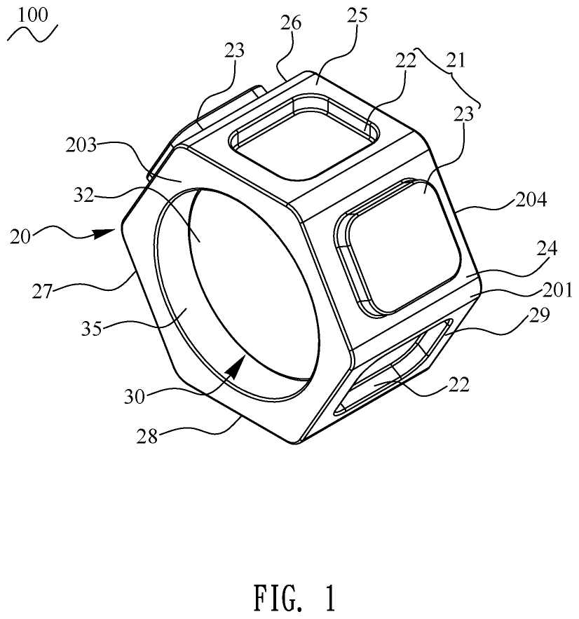

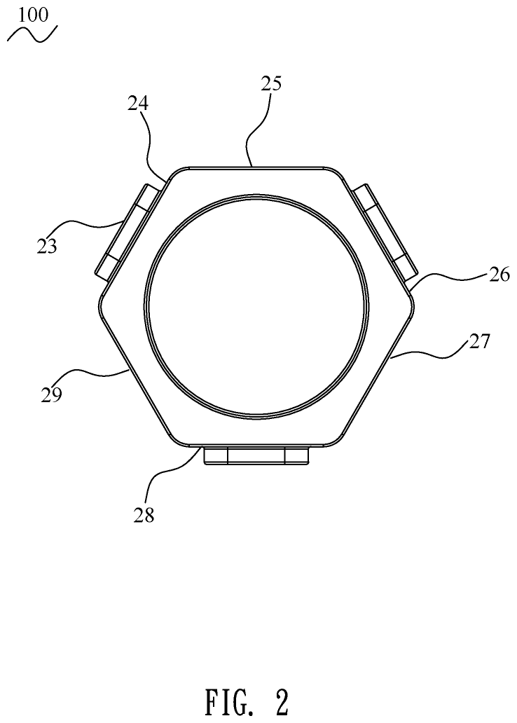

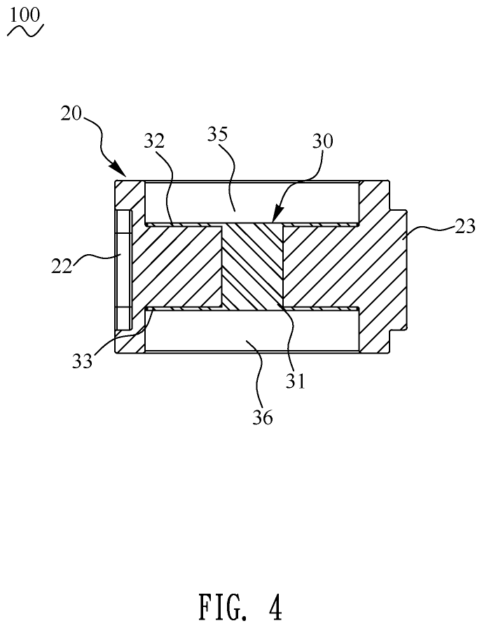

With reference to FIG. 1 to FIG. 9, a battery fastening structure 100 and a battery fastening structure assembly 200 in accordance with the present invention are shown. The battery fastening structure assembly 200 includes at least two battery fastening structures 100 for fastening at least one battery 40. Each battery fastening structure 100 includes an isolation unit 20 and a conduction unit 30.

The isolation unit 20 is of a polygon column shape. Preferably, the isolation unit 20 is of a hexagonal column shape. The isolation unit 20 is made of a fire-proof material. The isolation unit 20 has a front surface 203, a rear surface 204 opposite to the front surface 203, and an outer peripheral surface 201 connected between the front surface 203 and the rear surface 204 of the isolation unit 20. The isolation unit 20 has at least one combination unit 21 disposed to the outer peripheral surface 201 of the isolation unit 20. At least two battery fastening structures 100 are fastened and combined by virtue of at least two combination units 21 of the at least two battery fastening structures 100 being buckled. The at least one combination unit 21 includes a buckling recess 22, and a convex portion 23 matched with and adjacent to the buckling recess 22. The outer peripheral surface 201 of the isolation unit 20 has a first surface 24, a second surface 25, a third surface 26, a fourth surface 27, a fifth surface 28 and a sixth surface 29 which are arranged in an anticlockwise direction and arranged in sequence. The fourth surface 27 is opposite to and is parallel with the first surface 24. The fifth surface 28 is opposite to and is parallel with the second surface 25. The sixth surface 29 is opposite to and is parallel with the third surface 26. The isolation unit 20 opens a through-hole 202 penetrating through middles of the front surface 203 and the rear surface 204 of the isolation unit 20 along an axis direction X of the isolation unit 20. Two opposite ends of the through-hole 202 extend outward away from the middles of the front surface 203 and the rear surface 204 of the isolation unit 20 to form a first connecting hole 35 penetrating through the front surface 203 of the isolation unit 20 and a second connecting hole 36 penetrating through the rear surface 204 of the isolation unit 20, respectively.

Referring to FIG. 1 to FIG. 5, the buckling recess 22 is of a rectangular shape. The buckling recess 22 is recessed in an inward direction perpendicular to the axis direction X of the isolation unit 20 from the outer peripheral surface 201 of the isolation unit 20. The convex portion 23 is of a rectangular shape. The convex portion 23 is protruded in the outward direction perpendicular to the axis direction X of the isolation unit 20 from the outer peripheral surface 201 of the isolation unit 20 and projects beyond the outer peripheral surface 201 of the isolation unit 20. The buckling recess 22 and the convex portion 23 of the at least one combination unit 21 are located to at least two of the first surface 24, the second surface 25, the third surface 26, the fourth surface 27, the fifth surface 28 and the sixth surface 29. Preferably, the isolation unit 20 has three combination units 21, so the isolation unit 20 has three buckling recesses 22 and three convex portions 23. The three buckling recesses 22 and the three convex portions 23 of the isolation unit 20 are distributed at the first surface 24, the second surface 25, the third surface 26, the fourth surface 27, the fifth surface 28 and the sixth surface 29, and each buckling recess 22 is disposed between two convex portions 23. Specifically, the three buckling recesses 22 are distributed at the second surface 25, the fourth surface 27 and the sixth surface 29. The three convex portions 23 are distributed at the first surface 24, the third surface 26 and the fifth surface 28.

Referring to FIG. 1 to FIG. 8, the buckling recess 22 is matched with the convex portion 23. The convex portion 23 is capable of being buckled in the buckling recess 22 tightly, so the at least two battery fastening structures 100 are tightly buckled with each other by virtue of the convex portion 23 and the buckling recess 22 of the at least two battery fastening structures 100 being cooperated with and being buckled with each other. When the at least two battery fastening structures 100 are applied in the battery fastening structure assembly 200 for fastening a large capacity battery, the battery fastening structure assembly 200 includes the at least two battery fastening structures 100 is stabler, and the at least two battery fastening structures 100 are capable of being combined in different ways to form different battery fastening structure assemblies 200 by virtue of the at least two combination units 21 of the at least two battery fastening structures 100 being buckled.

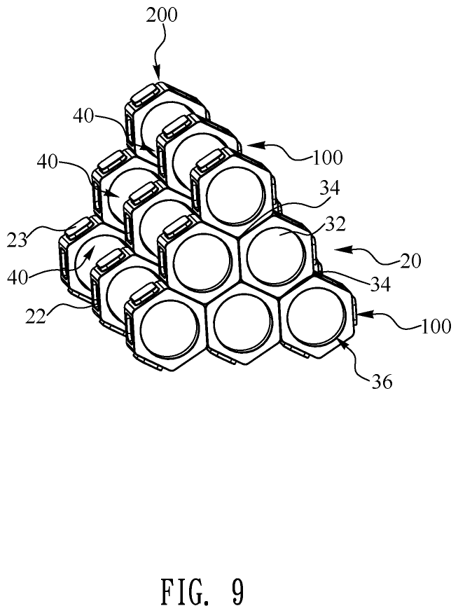

Referring to FIG. 9, the conduction unit 30 has a conductive column 31. One end of the conductive column 31 is connected with a middle of a first fastening piece 32, and the first fastening piece 32 is perpendicular to the conductive column 31. The other end of the conductive column 31 is connected with a middle of a second fastening piece 33, and the second fastening piece 33 is perpendicular to the conductive column 31, so that the second fastening piece 33 is parallel with the first fastening piece 32. The first fastening piece 32 and the second fastening piece 33 are of circular shapes, and a size of the first fastening piece 32 is equal to a size of the second fastening piece 33, so the conduction unit 30 is shown as an H shape.

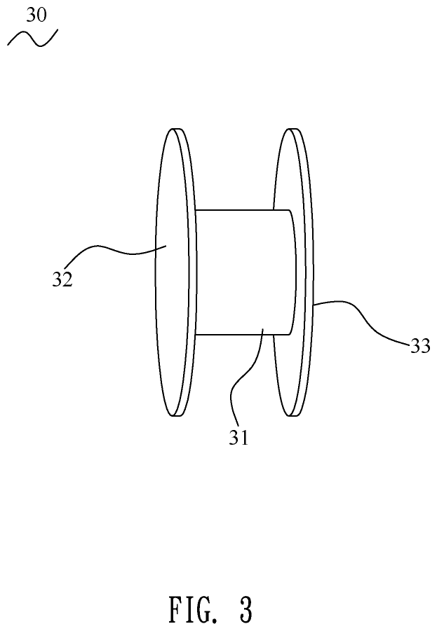

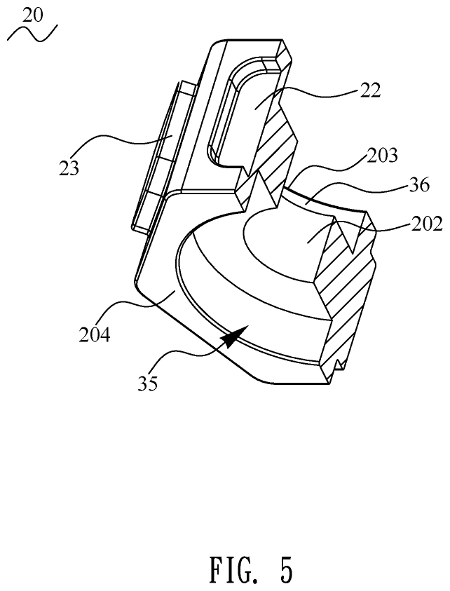

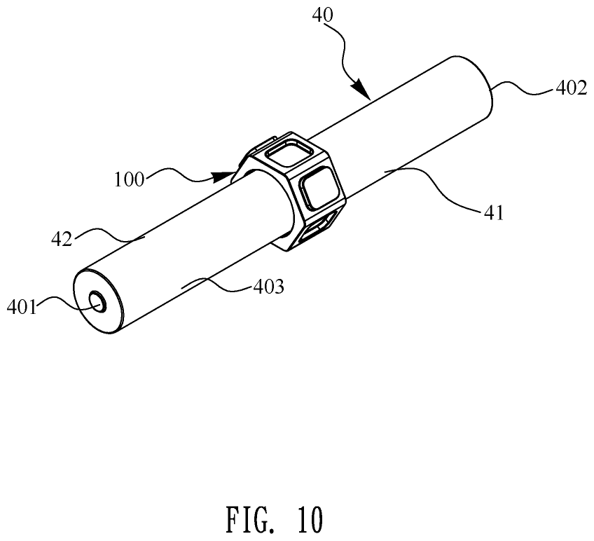

Referring to FIG. 1, FIG. 3, FIG. 5 and FIG. 10, the conduction unit 30 is disposed in the through-hole 202. The conduction unit 30 is neatly connected with the isolation unit 20, and two opposite ends of the conduction unit 30 are received in and exposed in the first connecting hole 35 and the second connecting hole 36, respectively. The first connecting hole 35 is disposed to one end of the isolation unit 20 and is designed for cooperating a positive pole 401 of a battery 40 to make one end of the conduction unit 30 electrically connected with the positive pole 401 of the battery 40, and the second connecting hole 36 is disposed to the other end of the isolation unit 20 and is designed for cooperating a negative pole 402 of the battery 40 to make the other end of the conduction unit 30 electrically connected with the negative pole 402 of the battery 40. The battery fastening structure 100 is for facilitating an electricity conduction of the battery 40 fastened therein. The isolation unit 20 and the conduction unit 30 of the battery fastening structure 100 are combined by an injection enveloping way, so that peripheries of the first fastening piece 32 and the second fastening piece 33 neatly abut against an inner surface of the isolation unit 20.

The first fastening piece 32 is received in the first connecting hole 35 and an outer surface of the first fastening piece 32 is exposed in the first connecting hole 35, and the second fastening piece 33 is received in the second connecting hole 36 and an outer surface of the second fastening piece 33 opposite to the outer surface of the first fastening piece 32 is exposed in the second connecting hole 36, so the first fastening piece 32 in the first connecting hole 35 is electrically connected with the second fastening piece 33 in the second connecting hole 36 by the conductive column 31. The first connecting hole 35 is located to one end of the through-hole 202 of one battery fastening structure 100, and the first connecting hole 35 of the one battery fastening structure 100 is equipped with the first fastening piece 32 for cooperating with the positive pole 401 of one battery 40, and the first fastening piece 32 in the first connecting hole 35 of the one battery fastening structure 100 is electrically connected with the positive pole 401 of the one battery 40.

The second connecting hole 36 is located to one end of the through-hole 202 of the other battery fastening structure 100, and the second connecting hole 36 of the other battery fastening structure 100 is equipped with the second fastening piece 33 for cooperating with the negative pole 402 of the one battery 40, and the second fastening piece 33 in the second connecting hole 36 of the other battery fastening structure 100 is electrically connected with the negative pole 402 of the one battery 40. Because the positive pole 401 and the negative pole 402 of two opposite ends of the one battery 40 are received in the first connecting hole 35 and the second connecting hole 36 of the two battery fastening structures 100, the first connecting hole 35 and the second connecting hole 36 are of hollow cylinder shapes, at the moment, the two opposite ends of the one battery 40 are connected with the first fastening piece 32 and the second fastening piece 33 of the two battery fastening structures 100, so the one battery 40 is fastened and conductive in the two battery fastening structures 100. A size of the first connecting hole 35 is equal to a size of the second connecting hole 36. Each battery 40 is 18650 type lithium battery. Each battery 40 is of a cylinder shape. Shapes of the positive pole 401 and the negative pole 402 of each battery 40 are similar with each other.

Referring to FIG. 1, and FIG. 10, the first connecting hole 35 is located to the one end of the through-hole 202 of the one battery fastening structure 100, and the first connecting hole 35 of the one battery fastening structure 100 is equipped with the first fastening piece 32 for cooperating with the positive pole 401 of the one battery 40, and the first fastening piece 32 in the first connecting hole 35 of the one battery fastening structure 100 is electrically connected with the positive pole 401 of the one battery 40, the second connecting hole 36 is located to the other end of the through-hole 202 of the one battery fastening structure 100, and the second connecting hole 36 is equipped with the second fastening piece 33 for cooperating with the negative pole 402 of the other battery 40, and the second fastening piece 33 in the second connecting hole 36 is electrically connected with the negative pole 402 of the other battery 40, so two batteries 40 are connected in series and conductive by virtue of the first fastening piece 32 in the first connecting hole 35 and the second fastening piece 33 in the second connecting hole 36 of the one battery fastening structure 100, so that a peripheral wall of the first connecting hole 35 surrounds the positive pole 401 of the one battery 40, and a peripheral wall of the second connecting hole 36 surrounds the negative pole 402 of the other battery 40, namely one end of the isolation unit 20 surrounds the positive pole 401 of the one battery 40, and the other end of the isolation unit 20 surrounds the negative pole 402 of the other battery 40, and electrodes of the two batteries 40 are protected. The two batteries 40 are connected in series and are conductive by virtue of the conduction unit 30, a nickel sheet (not shown) is without being needed to be spot soldered, so the battery 40 is avoided from being damaged on account of the nickel sheet being spot soldered.

Referring to FIG. 1 to FIG. 11, the at least two battery fastening structures 100 are capable of being flexibly combined to form the different battery fastening structure assemblies 200 which have various shapes, the battery fastening structure assembly 200 is one of rectangular shapes, parallelograms, triangles and other shapes.

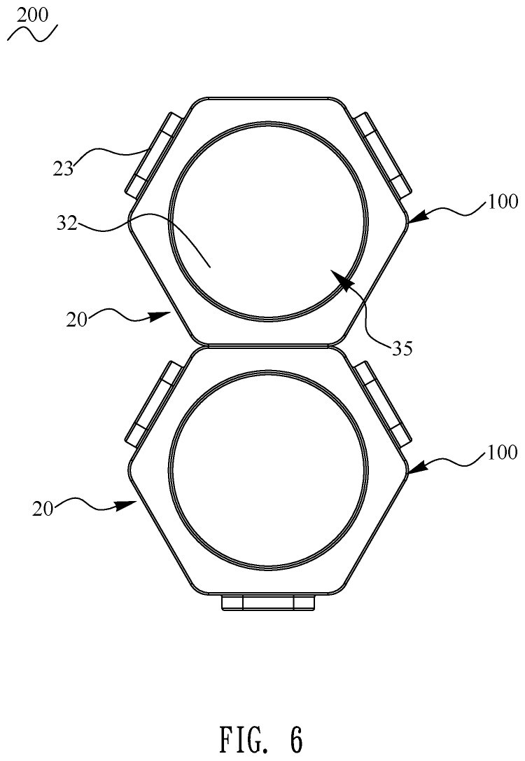

The battery fastening structure assembly 200 in accordance with a first preferred embodiment of the present invention is shown in FIG. 6. In the first preferred embodiment, the battery fastening structure assembly 200 is of the rectangular shape. The battery fastening structure assembly 200 includes nine battery fastening structures 100 arranged in three parallel rows along a front-to-rear direction. Each row of the battery fastening structure assembly 200 includes three battery fastening structures 100 which are connected by virtue of the convex portions 23 and the buckling recesses 22. Six batteries 40 are clamped among the three rows of the battery fastening structures 100 and are arranged in two rows along the front-to-rear direction. Each battery 40 is clamped between two adjacent battery fastening structures 100 disposed along the front-to-rear direction. The first surface 24 and the fourth surface 27 of the two battery fastening structures 100 located at two opposite sides of each row of the battery fastening structure assembly 200 and disposed vertically are exposed outside and are parallel with each other. The exposed first surfaces 24 of the three rows of the battery fastening structures 100 are aligned, and the exposed fourth surfaces 27 of the three rows of the battery fastening structures 100 are aligned. The front surfaces of the battery fastening structures 100 of each row of the battery fastening structure assembly 200 are aligned, and the rear surfaces 204 of the battery fastening structures 100 of each row of the battery fastening structure assembly 200 are aligned.

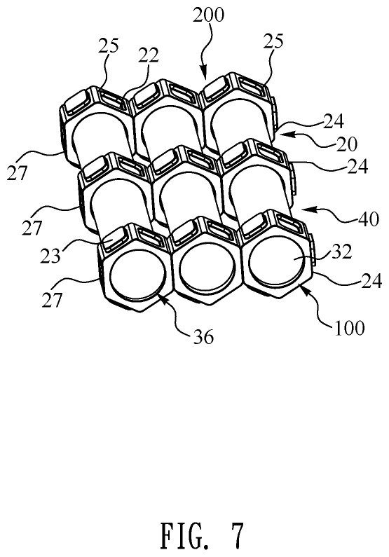

The battery fastening structure assembly 200 in accordance with a second preferred embodiment of the present invention is shown in FIG. 7. In the second preferred embodiment, the battery fastening structure assembly 200 is of the parallelogram shape. The battery fastening structure assembly 200 is composed of six rows of the battery fastening structures 100 which include eighteen battery fastening structures 100. The eighteen battery fastening structures 100 are arranged in two layers along an up-down direction, so the battery fastening structure assembly 200 includes a lower layer of the battery fastening structures 100, and an upper layer of the battery fastening structures 100 located on the lower layer of the battery fastening structures 100. Each layer of the battery fastening structure assembly 200 in accordance with the second preferred embodiment, includes nine battery fastening structures 100 arranged in three parallel rows and is shown as the rectangular shape which is the same as the shape of the battery fastening structure assembly 200 in accordance with the first preferred embodiment.

Two adjacent sides of tops of each two adjacent battery fastening structures 100 of each row of the battery fastening structure assembly 200 are spaced from each other to form an interval 34. Bottoms of two battery fastening structures 100 located at one side of each row of the upper layer of the battery fastening structure assembly 200 are inserted into the two intervals 34 of one row of the lower layer of the battery fastening structure assembly 200. The buckling recess 22 of an inner side of a bottom of one battery fastening structure 100 located at the other side of each row of the upper layer of the battery fastening structure assembly 200 faces to and is buckled with the convex portion 23 of an outer side of a top of one battery fastening structure 100 of one row of the lower layer of the battery fastening structure assembly 200.

Specifically, the buckling recess 22 of the fourth surface 27 of the one battery fastening structure 100 located at the other side of each row of the upper layer of the battery fastening structure assembly 200 is buckled with the convex portion 23 of the first surface 24 of the one battery fastening structure 100 of the one row of the lower layer of the battery fastening structure assembly 200. Twelve batteries 40 are clamped among the two layers of the battery fastening structures 100 and are arranged in two layers along the up-down direction. Six batteries 40 are clamped among the three rows of the battery fastening structures 100 of the upper layer of the battery fastening structure assembly 200 and are arranged in the two rows along the front-to-rear direction. The other six batteries 40 are clamped among the three rows of the battery fastening structures 100 of the lower layer of the battery fastening structure assembly 200 and are arranged in the two rows along the front-to-rear direction.

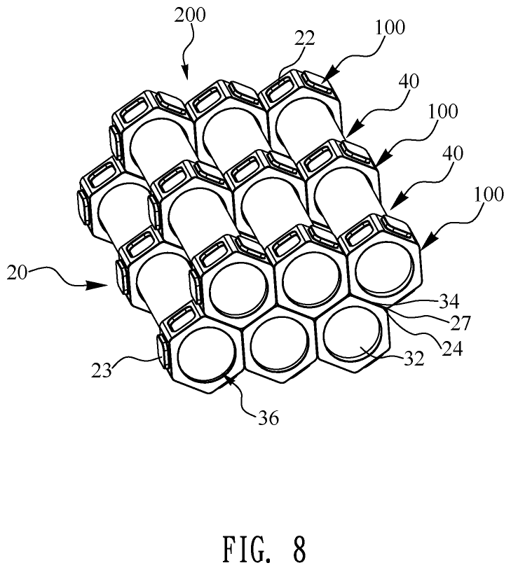

The battery fastening structure assembly 200 in accordance with a third preferred embodiment of the present invention is shown in FIG. 8. In the third preferred embodiment, the battery fastening structure assembly 200 is of the triangle shape. The battery fastening structure assembly 200 includes six battery fastening structures 100 arranged in three layers along the up-down direction. The battery fastening structure assembly 200 includes a bottom layer of the battery fastening structure assembly 200, a top layer of the battery fastening structure assembly 200, and a middle layer of the battery fastening structure assembly 200 located between the bottom layer of the battery fastening structure assembly 200 and the top player of the battery fastening structure assembly 200.

The bottom layer of the battery fastening structure assembly 200 includes nine battery fastening structures 100. The bottom layer of the battery fastening structure assembly 200 is of the rectangular shape which is the same as the battery fastening structure assembly 200 in accordance with the first preferred embodiment. The interval 34 is formed between the two battery fastening structures 100 of each row of the bottom layer of the battery fastening structure assembly 200. The middle layer of the battery fastening structure assembly 200 includes six battery fastening structures 100 arranged in three parallel rows, and the middle layer of the battery fastening structure assembly 200 is shown as a rectangle shape. Each row of the middle layer of the battery fastening structure assembly 200 includes two battery fastening structures 100. The interval 34 is formed between the two battery fastening structures 100 of each row of the middle layer of the battery fastening structure assembly 200. The top layer of the battery fastening structure assembly 200 includes three battery fastening structures 100 arranged in three rows and arranged in the front-to-rear direction, and the top layer of the battery fastening structure assembly 200 is shown as a straight line shape. Twelve batteries 40 are clamped among the three layers of the battery fastening structures 100 and are arranged in three layers. Each battery 40 is clamped between two adjacent battery fastening structures 100 disposed along the front-to-rear direction.

The middle layer of the battery fastening structure assembly 200 is mounted on the bottom layer of the battery fastening structure assembly 200, and the top player of the battery fastening structure assembly 200 is mounted on the middle layer of the battery fastening structure assembly 200. Specifically, the two battery fastening structures 100 of each row of the middle layer of the battery fastening structure assembly 200 are corresponding to and are inserted into the two intervals 34 of one row of the bottom layer of the battery fastening structure assembly 200. The battery fastening structure 100 of each row of the top layer of the battery fastening structure assembly 200 is corresponding to and is inserted into the interval 34 of one row of the middle layer of the battery fastening structure assembly 200.

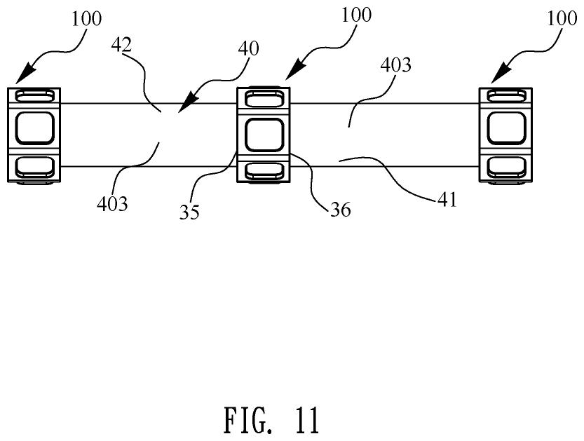

Referring to FIG. 1, FIG. 9, FIG. 10 and FIG. 11, the at least one battery 40 includes a first battery 41 and a second battery 42. The battery fastening structure 100 is connected with the positive pole 401 of the first battery 41 and the negative pole 402 of the second battery 42. The first battery 41 and the second battery 42 are of the 18650 type lithium battery. The negative pole 402 of the first battery 41 and the positive pole 401 of the second battery 42 are connected with two battery fastening structures 100, respectively, so that the first battery 41 and the second battery 42 are fastened among the three battery fastening structures 100. The first battery 41 and the second battery 42 are connected by virtue of the battery fastening structure 100 located between the first battery 41 and the second battery 42. The isolation units 20 of the three battery fastening structures 100 simultaneously surround the positive poles 401 and the negative poles 402 of the first battery 41 and the second battery 42, respectively. The positive pole 401 and the negative pole 402 of the first battery 41 are fastened in at least two battery fastening structures 100, and a base body 403 of the first battery 41 located between the positive pole 401 and the negative pole 402 of the first battery 41 is exposed outside, so when the first battery 41 is in operation, the first battery 41 is capable of proceeding a heat dissipation quickly.

As described above, the isolation unit 20 and the conduction unit 30 of the battery fastening structure 100 are combined by the injection enveloping way, so that the peripheries of the first fastening piece 32 and the second fastening piece 33 neatly abut against the inner surface of the isolation unit 20, when battery core liquids flow from the positive pole 401 or the negative pole 402 of the at least one battery 40 carelessly, because the conduction unit 30 is shown as the H shape, and the first fastening piece 32 or the second fastening piece 33 is neatly connected with the isolation unit 20, the battery core liquids are effectively isolated to be avoided flowing from one end of the at least one battery 40 to the other end of the at least one battery 40, an operation and a life of the other end of the at least one battery 40 are affected. Moreover, most explosion and burn sources of the at least one battery 40 are located at the positive pole 401 or the negative pole 402 of the at least one battery 40, the isolation unit 20 is made of the fire-proof material, and the positive pole 401 and the negative pole 402 of the at least one battery 40 are isolated and surrounded by the isolation unit 20, the seeped and flown battery core liquids are capable of being effectively isolated and a hazard of a serial of combustion of the at least one battery 40 is further capable of being avoided.

What is claimed is:

1. A battery fastening structure, comprising:
an isolation unit opening a through-hole penetrating through middles of a front surface and a rear surface of the isolation unit along an axis direction of the isolation unit, the isolation unit having at least one combination unit disposed to an outer peripheral surface of the isolation unit, at least two battery fastening structures being fastened and combined by virtue of at least two combination units of the at least two battery fastening structures being buckled; and
a conduction unit disposed in the through-hole, two opposite ends of the through-hole extending outward away from the middles of the front surface and the rear surface of the isolation unit to form a first connecting hole penetrating through the front surface of the isolation unit and a second connecting hole penetrating through the rear surface of the isolation unit, respectively, the conduction unit being neatly connected with the isolation unit, and two opposite ends of the conduction unit being received in and exposed in the first connecting hole and the second connecting hole, respectively, the first connecting hole being disposed to one end of the isolation unit and being designed for cooperating a positive pole of a battery to make one end of the conduction unit electrically connected with the positive pole of the battery, and the second connecting hole being disposed to the other end of the isolation unit and being designed for cooperating a negative pole of the battery to make the other end of the conduction unit electrically connected with the negative pole of the battery.

2. The battery fastening structure as claimed in claim 1, wherein the conduction unit has a conductive column, one end of the conductive column is connected with a first fastening piece, and the first fastening piece is perpendicular to the conductive column, the other end of the conductive column is connected with a second fastening piece, and the second fastening piece is perpendicular to the conductive column, so that the second fastening piece is parallel with the first fastening piece, the conduction unit is disposed in the through-hole, peripheries of the first fastening piece and the second fastening piece neatly abut against an inner surface of the isolation unit, the first fastening piece is received in the first connecting hole and an outer surface of the first fastening piece is exposed in the first connecting hole, and the second fastening piece is received in the second connecting hole and an outer surface of the second fastening piece opposite to the outer surface of the first fastening piece is exposed in the second connecting hole.

3. The battery fastening structure as claimed in claim 2, wherein the first fastening piece and the second fastening piece are of circular shapes, and a size of the first fastening piece is equal to a size of the second fastening piece, so the conduction unit is shown as an H shape.

4. The battery fastening structure as claimed in claim 2, wherein the first connecting hole is located to one end of the through-hole of one battery fastening structure, and the first connecting hole is equipped with the first fastening piece for cooperating with the positive pole of the one battery, and the first fastening piece in the first connecting hole is electrically connected with the positive pole of the one battery, the second connecting hole is located to the other end of the through-hole of the one battery fastening structure, and the second connecting hole is equipped with the second fastening piece for cooperating with the negative pole of the other battery, and the second fastening piece in the second connecting hole is electrically connected with the negative pole of the other battery, so the two batteries are connected in series and conductive by virtue of the first fastening piece in the first connecting hole and the second fastening piece in the second connecting hole of the one battery fastening structure.

5. The battery fastening structure as claimed in claim 2, wherein the first connecting hole is located to one end of the through-hole of one battery fastening structure, and the first connecting hole of the one battery fastening structure is equipped with the first fastening piece for cooperating with the positive pole of one battery, and the first fastening piece in the first connecting hole of one battery fastening structure is electrically connected with the positive pole of the one battery, the second connecting hole is located to one end of the through-hole of the other battery fastening structure, and the second connecting hole of the other battery fastening structure is equipped with the second fastening piece for cooperating with the negative pole of the one battery, and the second fastening piece in the second connecting hole of the other battery fastening structure is electrically connected with the negative pole of the one battery, so the one battery is fastened and conductive in the two battery fastening structures.

6. The battery fastening structure as claimed in claim 1, wherein the isolation unit is of a hexagonal column shape.

7. The battery fastening structure as claimed in claim 1, wherein the isolation unit has an outer peripheral surface connected between the front surface and the rear surface of the isolation unit, the at least one combination unit is disposed to the outer peripheral surface of the isolation unit.

8. The battery fastening structure as claimed in claim 1, wherein the isolation unit is made of a fire-proof material.

9. The battery fastening structure as claimed in claim 1, wherein the isolation unit is of a polygon column shape.

10. The battery fastening structure as claimed in claim 1, wherein the battery fastening structure assembly includes at least two battery fastening structures for fastening at least one battery.

11. The battery fastening structure as claimed in claim 1, wherein the battery fastening structure assembly is one of rectangular shapes, parallelograms, triangles and other shapes.

12. The battery fastening structure as claimed in claim 1, wherein the at least one combination unit includes a buckling recess, and a convex portion matched with and adjacent to the buckling recess, the at least two battery fastening structures are capable of being combined in different ways to form different battery fastening structure assemblies by virtue of the at least two combination units of the at least two battery fastening structures being buckled.

13. The battery fastening structure as claimed in claim 12, wherein the isolation unit has three buckling recesses and three convex portions, the outer peripheral surface of the isolation unit has a first surface, a second surface, a third surface, a fourth surface, a fifth surface and a sixth surface which are arranged in an anticlockwise direction and arranged in sequence, the three buckling recesses and the three convex portions are distributed at the first surface, the second surface, the third surface, the fourth surface, the fifth surface and the sixth surface, and each buckling recess is disposed between two convex portions.

14. The battery fastening structure as claimed in claim 13, wherein the fourth surface is opposite to and is parallel with the first surface, the fifth surface is opposite to and is parallel with the second surface, the sixth surface is opposite to and is parallel with the third surface.

15. A battery fastening structure assembly, comprising:
at least two battery fastening structures for fastening at least one battery, each battery fastening structure including:
an isolation unit opening a through-hole penetrating through middles of a front surface and a rear surface of the isolation unit along an axis direction of the isolation unit, the isolation unit having at least one combination unit disposed to an outer peripheral surface of the isolation unit, the at least two battery fastening structures being fastened and combined by virtue of at least two combination units of the at least two battery fastening structures being buckled; and
a conduction unit disposed in the through-hole, two opposite ends of the through-hole extending outward away from the middles of the front surface and the rear surface of the isolation unit to form a first connecting hole penetrating through the front surface of the isolation unit and a second connecting hole penetrating through the rear surface of the isolation unit, respectively, the conduction unit being neatly connected with the isolation unit, and two opposite ends of the conduction unit being received in and exposed in the first connecting hole and the second connecting hole, respectively, the first connecting hole being disposed to one end of the isolation unit and being designed for cooperating a positive pole of a battery to make one end of the conduction unit electrically connected with the positive pole of the battery, and the second connecting hole being disposed to the other end of the isolation unit and being designed for cooperating a negative pole of the battery to make the other end of the conduction unit electrically connected with the negative pole of the battery.

16. The battery fastening structure assembly as claimed in claim 15, wherein the at least one combination unit includes a buckling recess, and a convex portion matched with and adjacent to the buckling recess, the at least two battery fastening structures are capable of being combined in different ways to form different battery fastening structure assemblies by virtue of the at least two combination units of the at least two battery fastening structures being buckled.

17. The battery fastening structure assembly as claimed in claim 15, wherein the battery fastening structure assembly is one of rectangular shapes, parallelograms, triangles and other shapes.

18. A battery fastening structure assembly, comprising:
at least two battery fastening structures for fastening at least one battery, each battery fastening structure including:
an isolation unit opening a through-hole penetrating through middles of a front surface and a rear surface of the isolation unit along an axis direction of the isolation unit, the isolation unit having at least one combination unit disposed to an outer peripheral surface of the isolation unit, the at least two battery fastening structures being fastened and combined by virtue of at least two combination units of the at least two battery fastening structures being buckled; and
a conduction unit disposed in the through-hole, two opposite ends of the through-hole extending outward away from the middles of the front surface and the rear surface of the isolation unit to form a first connecting hole penetrating through the front surface of the isolation unit and a second connecting hole penetrating through the rear surface of the isolation unit, respectively, the conduction unit being neatly connected with the isolation unit, the conduction unit having a conductive column, one end of the conductive column being connected with a first fastening piece, and the other end of the conductive column being connected with a second fastening piece, the first fastening piece being received in the first connecting hole and an outer surface of the first fastening piece being exposed in the first connecting hole, and the second fastening piece being received in the second connecting hole and an outer surface of the second fastening piece opposite to the outer surface of the first fastening piece being exposed in the second connecting hole, the first connecting hole being located to one end of the through-hole of one battery fastening structure, and the first connecting hole being equipped with the first fastening piece for cooperating with a positive pole of one battery, and the first fastening piece in the first connecting hole being electrically connected with the positive pole of the one battery, the second connecting hole being located to the other end of the through-hole of the one battery fastening structure, and the second connecting hole being equipped with the second fastening piece for cooperating with a negative pole of the other battery, and the second fastening piece in the second connecting hole being electrically connected with the negative pole of the other battery.

19. The battery fastening structure assembly as claimed in claim 18, wherein the first connecting hole is located to one end of the through-hole of the one battery fastening structure, and the first connecting hole of the one battery fastening structure is equipped with the first fastening piece for cooperating with the positive pole of the one battery, and the first fastening piece in the first connecting hole of one battery fastening structure is electrically connected with the positive pole of the one battery, the second connecting hole is located to one end of the through-hole of the other battery fastening structure, and the second connecting hole of the other battery fastening structure is equipped with the second fastening piece for cooperating with the negative pole of the one battery, and the second fastening piece in the second connecting hole of the other battery fastening structure is electrically connected with the negative pole of the one battery, so the one battery is fastened and conductive in the two battery fastening structures.

20. The battery fastening structure assembly as claimed in claim 18, wherein the at least one combination unit includes a buckling recess, and a convex portion matched with and adjacent to the buckling recess, the at least two battery fastening structures are capable of being combined in different ways to form different battery fastening structure assemblies by virtue of the at least two combination units of the at least two battery fastening structures being buckled.
